(19) United States
(12) Patent Application Publication
(10) Pub. No.: US 2017/0367277 A1
(43) Pub. Date: Dec. 28, 2017

(54) PLANT WATERING AND COMMUNICATION SYSTEM

(71) Applicant: Rishi Mohindra, Milpitas, CA (US)

(72) Inventor: Rishi Mohindra, Milpitas, CA (US)

(21) Appl. No.: 15/193,120

(22) Filed: Jun. 27, 2016

(51) Int. Cl. A01G 27/00; A01G 25/02; A01G 25/16; G05D 7/06; A01G 1/00

(52) U.S. Cl. CPC A01G 27/003; G05D 7/0676; A01G 27/008; A01G 27/005; A01G 1/001; A01G 25/167; A01G 25/023; A01G 27/001

(57) ABSTRACT

A method for watering plants using a self-contained high pressure distribution system with a water reservoir. A mini gear pump is used for pumping water to pressure compensated drip emitters at individual plants. A method for monitoring soil moisture content and programming of individual watering of plants through an energy efficient wireless networking system. The high-pressure water in the plant watering system is used as a communication physical channel for the wireless networking for improving wireless communication range and battery life of wireless terminals. Chip-level Differential Encoding based Spread Spectrum signaling is used for reducing wireless networking solution cost, improving wireless link budget, improving immunity to interference, and increasing battery life of wireless terminals.

### RELATED APPLICATIONS

This application claims the benefit of U.S. Patent Provisional Application No. 62/185,718, filed Jun. 28, 2015, and titled “PLANT WATERING AND COMMUNICATION SYSTEM,” which is herein incorporated by reference in its entirety.

The present invention relates to a method and system for watering plants, and for monitoring soil moisture content and programming individual watering of plants through an energy efficient wireless networking system.

The present application is related to United States patent application US 2007/0089365 A1, dated Apr. 26, 2007, for plant watering system, included by reference herein.

### FIELD OF THE INVENTION

This invention relates to a method and system for watering plants, and a low power communication system for monitoring soil moisture and temperature, and for programing plant watering.

### BACKGROUND

The most significant problem in tending to indoor potted plants is watering them regularly with the right dozes especially when being away for a prolonged period of time. While there are timer-based high-pressure drip systems for watering outdoor plants, they cannot be safely used indoors due to risk of flooding with breakage of plant watering pipes that are connected to the main water supply of the home or office with a pressure usually in the range of 40-80 psi. An alternative solution using a reservoir based self-contained high-pressure drip watering system is not available in the market. There are reservoir based self-contained gravity fed low-pressure indoor watering systems available, but they require individual watering pipes under control of individual solenoid valves to run to each potted plant from the central reservoir. Due to the number of pipes running and the need for placing the reservoir at a level above the plant water dispenser head's level, the system is not aesthetically appealing and is cumbersome to set up.

There is a need for sensing the moisture level in each of the potted plant's soil and appropriately adjusting the individual plant's watering automatically.

There is also a need for electronically monitoring and reporting the moisture level in the potted plant soil over time, and the amount of water dispensed over a period of time. Similarly there is a need to electronically program the water dosage and watering interval through a user interface on a personal computer or a smart phone. A battery-based wireless transceiver could be used at each potted plant to send and receive information to and from a central unit or a personal computer or a smart phone or a hub over a wireless network. A wireless networking solutions for each individual potted plant would be expensive, and also require frequent replacement of the battery due to the power consumed by the wireless transceiver in overcoming the network requirements like operating range, maximum transmit power and wireless link budget with a suitable link margin. There is a need for a very low power communication system that could use a small battery for 10 years without replacement. In fact there is a need for a battery-less energy harvesting based communication system that can monitor as well as control the watering of the individual plants.

There is a need for connecting the plant watering system to the “Internet of Things” (IoT) in order to remotely monitor various parameters including soil moisture and ambient temperature, and water reservoir level, and to remotely program the watering system. In fact it is desirable to have the system work as part of a general wireless sensing and control network with hundreds if not thousands of sensors connected to the IoT through a gateway. Such a system could include sensors used for burglar alarms, gas/water/electricity meter reading, heating/cooling thermostat reading and temperature control, indoor/outdoor temperature reading, door lock control, blinds control, water leakage and flooding sensing, motion sensing and proximity sensing, lawn and outdoor plant soil moisture monitoring etc. A ten-year battery life would be desirable for each of the potted plant's electronic device that would be used for the purpose of watering control, soil moisture and light sensing, and wireless data communication.

### SUMMARY OF THE INVENTION

In view of the foregoing, a self-contained plant watering system and a very low power and very long battery life wireless communication system is disclosed for overcoming the known drawbacks.

In one embodiment, the system includes an electronically timed high pressure water delivery subsystem with a self-contained water reservoir that is connected through a water pump to individual pressure compensated drip emitters at each of the potted plants using a common high-pressure water delivery tube. The water reservoir is not pressurized and the water in it is exposed to atmospheric pressure. The drip emitters can have different flow rates like 0.5 GPH (gallons per hour), 1 GPH, 2 GPH, 5 GPH etc. to meet the individual watering need of each plant. They provide a fairly constant flow rate over a wide operating water pressure range for example in the range of 10 psi to 60 psi. A special water pump, preferably a mini gear water pump, is used to pump water from the reservoir to a common water tubing that connects to each of the drip emitter at each plant. The common water tubing could be a flexible PVC or polythene or plastic pipe with a ¼ inch outer diameter (OD) that is commonly used for drip irrigation. A ¼ inch tubing compatible plastic T-Junction water tubing connector is used to connect each individual drip emitter to the common water tubing. A mini gear water pump with a suitable flow rate versus water pressure characteristic is selected to provide the appropriate operating water pressure over a wide range of length of the water tubing with associated flow friction loss, and over a wide range of the number of potted plants and the number of drip emitters. A manual or electronically controlled release valve is optionally used to divert part of the water flow from the output of the pump back to the water reservoir or pump intake when the total water flow to the plants is set up to be below a certain threshold. This is be done to ensure that the maximum pressure of the water tubing and the drip emitters is not exceeded under low flow rates since the water pressure at the output of the pump increases with reduction in flow rate. It is also used to ensure that there is a minimum flow that is required for the self-priming of the water pump and to remove air bubbles in the intake path, especially when the system is set up such that the pump intake is above the water level of the reservoir. The water pump and the electronic timer could be powered from a transformer-based or a switch mode based DC power supply that converts the home A/C power into DC. A rechargeable or non-rechargeable battery backup with electronic switchover could be used to power the system during electrical outage of the home A/C power. The system may include a ground fault circuit interrupter (GFCI) protection to shut off the A/C power in case of water spill coming in contact with high voltage A/C power wiring either directly, or indirectly through a non-isolated DC power supply.

In one embodiment the release valve comprises a pressure compensated constant flow rate drip emitter e.g. with a rating of 5 GPH, in series with a manually or electronically operated valve that is hereby named a bypass valve. This bypass valve is kept open to enable reflow of water from the pump output back to the water reservoir or pump intake when the total drip rate for the plants is less than a predetermined threshold like 5 GPH as an example. When the total drip rate for the plants is set up to exceed 5 GPH, the bypass valve is kept closed in order to prevent re-flow of water back to the water reservoir or intake. This ensures that the minimum flow rate is at least 5 GPH at the pump output independent of the total water flow rate to the plants. The mini gear pump is designed such that the output pressure meets the safe operating pressure requirements of the drip emitters and tubing when the total flow rate at the pump output is at a certain value like 5 GPH in this example. As an example, if the operating pressure range of the pressure compensated drip emitters and water tubing is 10-60 psi, then a mini gear pump can be designed to have an output pressure of 45 psi at 5 GPH flowrate. A mini gear pump is preferred over a diaphragm pump as it provides a smooth non-pulsed water flow with a fairly constant pressure. A diaphragm pump on the other hand has large pulsed water pressure variations and is not conducive for drip emitters for maintaining a constant flow rate, and the output pulsed pressure of diaphragm pumps may also periodically exceed the rating of the water tubing. A peristaltic pump usually will not be able to provide the required water pressure in the range of 45 psi for 5 GPH flow rate. It should be noted that the value of 5 GPH is only an example, while other suitable values in the range of 0.5 to 30 GPH can be considered. Similarly, the ¼ inch tubing can be replace by other diameter of water tubing. In an embodiment, the mini gear pump may include a pressure switch or a return valve for protection at very low flow rate.

The system may include a pressure sensor at the pump output and a closed-loop electronic control system that adjusts the supply voltage or current to the motor of the water pump such that the output pressure is maintained within a required range over a specified range of flowrate. In another embodiment, a microcontroller may be used to sense the output pressure based on which the release valve could be opened should the pressure exceed a threshold amount. In yet another embodiment, the microcontroller may shut off the water pump should the output pressure be below a certain threshold indicating leakage or breakage in the output tubing.

The system may include an electronically operated valve that could be a solenoid valve, placed in series with the common water tubing, in order to prevent leakage of water from the reservoir to the drip emitters when the pump is off and if the water level in the reservoir is above that of any of the drip emitters at the plants. It prevents flow or siphoning of water from a higher level to a lower level. The power supply to this valve is controlled by the same timer that operates the water pump, such that the valve is opened when the pump is operational, and closed otherwise.

The system may include buttons, rotary knobs, displays or other human interface devices including trackpad and touch panels, for setting the operating parameters and for manually controlling the system when required. The operating parameters can include the number of minutes the pump is activated each time, the number of times per week the pump is activated, or the days of the week the pump is activated, and the starting time. Manual controlling of the system can include manually switching on and switching off the water pump, and/or testing of other electromechanical components in the system, and for initial priming of the water pump if required. Manual control could include reversing the pump so that water is sucked back from the common tubing and drip emitters in order to flush the system. Flushing the system helps in preventing water from dripping onto the floor or carpet from emitters and cut tubing when work is being conducted at the output distribution system for connecting new emitters or new tubing, or when moving the drip emitters or repositioning them.

In one embodiment, each potted plant has a drip emitter with a preselected drip rate tailored to the plants watering requirements. In another embodiment, the flow of water to each plant is additionally locally controlled by a solenoid valve in series with the intake of the pressure compensated drip emitter. This allows individually reducing the flow time to each plant instead of having a fixed flow time that is determined by the duration of the water pump being switched on. A local plant soil moisture sensor is used to determine the watering requirements for the plant and the associated control of the solenoid valve, by a local microcomputer with a local battery based power supply. A local water pressure sensor or switch at the solenoid valves intake is used to determine when the water pump is active as indicated by the pressure exceeding a certain threshold value, as determined by the local microcomputer.

In one embodiment, the local solenoid valve is a latch type that is normally open when electrical power is not applied to the solenoid. To close the valve, only a momentary pulsed electric power supply is required in order to latch the valve to the closed condition, and this is chosen in order to conserve and reduce battery drain. The valve is designed such that when the input pressure drops below a certain threshold i.e. when the water pump is shut off, the valve is automatically opened even though no electrical power is applied or removed. Alternatively, the solenoid valve could be latched-on and latched-off type using pulsed electric power under the control of the local microcomputer interfacing through solid-state switches or electromechanical relay switches.

In one embodiment, a local miniature water turbine coupled to a generator at each plant is used to generate electricity for its local control system. When the pump switches on, the water flow rotates the turbine that is coupled to an AC or DC micro motor that serves as a generator. The principle is similar to that of a hydroelectric power station, but at a miniature scale. The generated electricity is used to charge capacitors that are used to power the local microcomputer and soil moisture sensing system, and the pulsed solenoid valve. In this case the pressure compensated drip emitters are not used for the local watering control. The total water flow through the water turbine is measured using a flow sensor that could be part of the water turbine for counting the total number of revolutions of the turbine. When a predetermined amount of water has flowed through the turbine, the latched solenoid valve placed at the input of the water turbine is used to shut off the water flow. When the water pressure drops after the water pump has been shut off, the solenoid valve can be re-opened either by the microcomputer ore by the self-acting valve itself. A pressure switch or a pressure sensor at the input of the solenoid valve can be used by the microcomputer to determine the water pressure.

In one embodiment, the water is not directly dispensed on to the soil from the drip emitters or miniature turbine at some of the plants. Instead, a terra cotta or ceramic spike that is hollow from inside is used to disperse the water slowly into the soil. It is similar to the popular wine bottle based “Plant Nanny” system. Instead of the wine bottle holding water that feeds the terra cotta spike for dispersing water into the soil by gravity and diffusion, the water is instead supplied from the drip emitters or miniature turbine at some of the plants. This enables plants to absorb water over a longer duration compared to the time over which the water pump is switched on.

In one embodiment, the water in the common tubing that feeds water to each plant, is used as a conductive electrical communication physical channel over which electronic transceivers that are placed at each plant can communicate with a master controller or network hub that is attached anywhere to the water tubing or preferably at the water pump where higher capacity electric power is available. The water tubing can be made of nonconductive plastic material. In one embodiment the water in the common tubing is used for conducting electrical energy for the wireless communication among the transceivers, much like a wired connection with a distributed series resistance, and a distributed shunt capacitance to ground. In this case the wavelength of the subcarrier that is used for the wireless communication is greater or comparable to the length of the water tubing. In another embodiment the water in the common tubing is used for radiating electrical energy for the wireless communication among the transceivers, like an antenna. In this case the wavelength of the subcarrier that is used for wireless communication is smaller than the length of the water tubing. In the case where conductive electrical energy is used for the wireless communication through the water tubing, the return path comprises of the parasitic capacitance of individual plant pots with respect to the earth ground. The transceiver at the network hub could have a ground connection directly with the earth ground of the home wiring. Alternatively, the water in the reservoir along with its parasitic capacitance to earth's ground, could be used as a reference ground. In this case the significant electrical resistance of the water between the reservoir and the common tubing at the network hub transmit/receive port ports would prevent short-circuiting of the electrical communication energy for the network hub. At the potted plants a diffuser is used at the drip emitter to ensure that the water does not form a continuous electrically conducting column that would short the electrical energy in the water tubing to the plant soil that is used as a reference ground by the local wireless transceiver. The electrical connection of the transceiver's transmit and receive ports with the water in the common tubing can be implemented using a conductive probe piercing through the nonconductive tubing, or by inserting a short piece of conductive tubing in the path of the water flow. In one embodiment the tubing itself could be made of conductive material or have a conductive coating either on the inside or outside or both. The conductive part of the tubing could be used for conducting or radiating electrical communication energy, and for making electrical contacts with the transmit and the receive ports of the wireless transceivers.

In one embodiment, a dedicated electrical antenna at each transceiver is used for the wireless communication.

In one embodiment, a wireless communication for sensing, monitoring and control using either a dedicated antenna or the water tubing as either an antenna or as a conductive electrical communication medium, comprises of a digital spread Spectrum system wherein data to be transmitted is spread using a pseudorandom code-based chip sequence, and differential binary phase shift keying encoding and modulation is incorporated at the chip level after the spreading. Additionally, forward error correction is incorporated for the source data before spreading, using interleaving and convolutional encoding. The wireless communication system comprises a star network in which communication occurs between the central hub call the master, and the sensors or local control units called the slaves. Most of the slaves are battery powered and transmit randomly in an uncoordinated manner. Some slaves are transmit only devices, while others can transmit as well as receive. In order to save battery power the receive-enabled slaves only turn on their receiver after a predetermined duration from the end of their last transmission. This predetermined duration is conveyed as part of the transmit data from the slave to the master. The master only transmits to any slave precisely after this predetermined duration from the end of transmission by that particular slave. By adopting this method, the slaves do not need to wake up periodically for synchronisation with the master or with other slaves, thereby significantly reducing battery drain. In case of a lost packet e.g. due to interference or fading, a slave would not a valid (error free) signal from the master after this predetermined duration, or would receive a valid negative acknowledgement signal from the master indicating corruption of the received signal at the master. In either case the slave would retransmit again after a random duration. By randomising the start of the transmit time, the slaves minimise collisions among themselves. A collision between the slaves would only occur if the start time offset between any two slaves is on the order of 0-2 chip duration since any duration larger than this would result in close to 0 crosscorrelation of their chip sequences. Some of the slaves could be transmit only devices e.g. those used simply for monitoring soil moisture content, or for monitoring opening and closing of doors and windows. For the uplink i.e. transmission from slaves to master, all slaves would use an identical PN spreading code sequence. The transmit frequency would preferably be in an unlicensed band like 900 MHz, 2.4 GHz or 5 GHz. For the downlink i.e. transmission from master to slaves, preferably a different and non-overlapping frequency band would be used, and also preferably in an unlicensed band. By using different frequencies for the uplink and downlink i.e. by incorporating frequency division duplexing with half division duplexing (FDD-HD), collisions are avoided between master and slaves. However, in a lightly loaded network the uplink and downlink frequencies could be the same as it would only have a small impact on the battery drain of the slave units due to occasional collisions between master and slaves. It would correspond to time division duplexing (TDD). In this case the PN code for the downlink is preferably different from that of the uplink with close to zero crosscorrelation between them. Gold codes or Complimentary code sequences could be selected for these PN code sequences.

In one embodiment, the slaves could successively transmit the same data over different frequency bands with random time offsets between each transmission in order to overcome any deliberate jamming attempts by intruders. The master would simultaneously listen to each of these frequency bands. The received modulated signal in each frequency band could be downconverted by the master to complex in-phase and quadrature-phase zero IF baseband signals. The complex signals from each receiver could then be summed up and digitised using analog to digital converters, and then fed to a common complex differential binary phase shift keying decoder followed by a spread spectrum decoder.

In one embodiment, the spread spectrum decoder is capable of performing a full-length PN code sequence correlation with the incoming signal for every sample of the signal. When a strong correlation is detected at a particular sample of the input signal stream, the corresponding timing offset information (relative to a notional reference time) is handed over to a tracking system that uses a delay locked loop for maintaining code synchronisation for the de-spreading of that particular signal with that particular timing offset. Multiple tracking systems can be used in the master for simultaneously receiving overlapped signals from different slaves in order to reduce their battery drain from retransmissions due to failed acknowledgements or negative acknowledgements from the master. As noted before, in order to avoid collision the overlapping signals from different slaves must have a time offset off two or more chips between them. The time offset is computed using modulo arithmetic with the PN code sequence duration as a repetition interval.

In one embodiment, the wireless communication system uses encryption technology that is based on transferring a secret key from the master to a new slave that needs to be introduced into the network. The key transfer could be done using a hardwired USB connection or by manually entering a code, especially for transmit only slaves. In order to prevent impersonation, a rolling code or message count can be used as part of the message for transmit only slaves, wherein every transmit packet has a new code or message count when compared to a large number of consecutive previous course or future codes.

### DRAWINGS

FIG. 1 illustrates a plant watering system in accordance with an embodiment of the invention;

FIG. 2 illustrates a plant watering system in accordance with an embodiment of the invention;

FIG. 3 illustrates a plant watering system with a closed-loop electronic control of the water pump in accordance with an embodiment of the invention;

FIG. 4 illustrates a local control for individual plant watering in accordance with an embodiment of the invention;

FIG. 5 illustrates an example of a latched solenoid valve;

FIG. 6 illustrates a local control for individual plant watering with local generation of electricity in accordance with an embodiment of the invention;

FIG. 7 illustrates the use of water inside common tubing for the purpose of electrical communication in accordance with an embodiment of the invention;

FIG. 8 illustrates the block diagram of a spread spectrum transmitter with chip level differential binary phase shift keying in accordance with an embodiment of the invention;

FIG. 9 illustrates a block diagram of a spread spectrum receiver analog front-end in accordance with an embodiment of the invention;

FIG. 10 illustrates a block diagram of a Spread Spectrum Despreader with chip-level differential binary phase shift demodulation, used for a Searcher in accordance with an embodiment of the invention.

FIG. 11 illustrates a block diagram of a Spread Spectrum Tracker using a delay locked loop.

### DETAILED DESCRIPTION

In the following description of preferred embodiments, reference is made to the accompanying drawings which form a part hereof, and in which it is shown by way of illustration specific embodiments in which the invention can be practiced. It is to be understood that other embodiments can be used and structural changes can be made without departing from the scope of the embodiments of this invention.

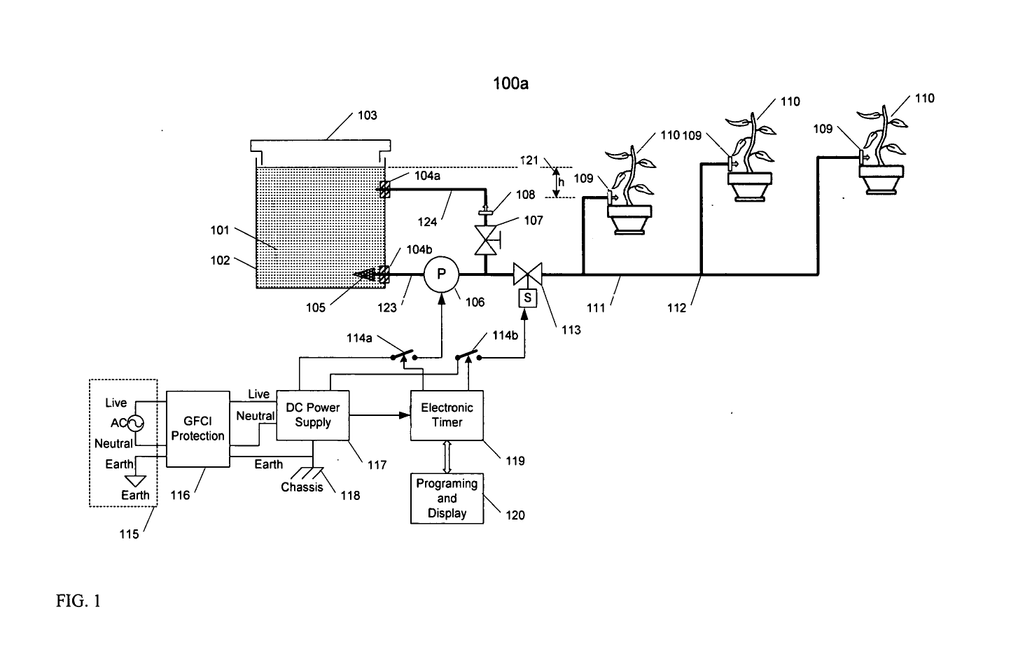

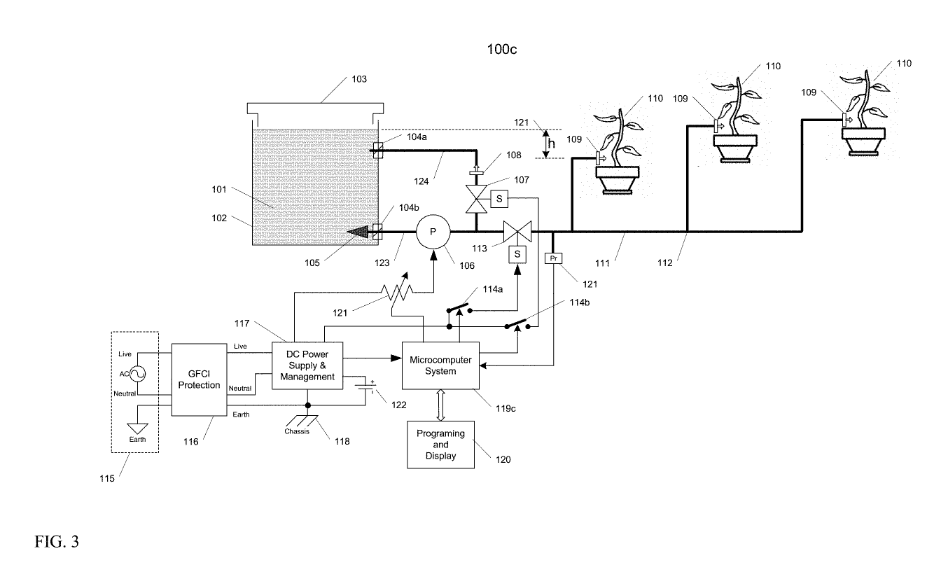

As shown in FIG. 1, the system includes an electronically timed high pressure water delivery subsystem 100a with a self-contained water 101 reservoir 102 that is connected through a water pump 106 to individual pressure compensated drip emitters 109 at each of the potted plants 110 using a common high-pressure water delivery tube 111. The drip emitters can have different flow rates like 0.5 GPH (gallons per hour), 1 GPH, 2 GPH, 5 GPH etc to meet the individual watering need of each plant. They provide a fairly constant flow rate over a wide operating water pressure range for example in the range of 10 psi to 60 psi. A special water pump, preferably a mini gear water pump 106, is used to pump water from the reservoir 102 to a common water tubing 111 that connects to each of the drip emitter 109 at each plant 110. The common water tubing 111 could be a flexible PVC or polythene or plastic pipe with a ¼ inch outer diameter (OD) that is commonly used for drip irrigation. A T-Junction water tubing connector 112 is used to connect each individual drip emitter 109 to the common water tubing 111. A mini gear water pump 106 with a suitable flow rate versus water pressure is selected to provide the appropriate operating water pressure over a wide range of length of the water tubing with associated flow friction loss, and over a wide range of the number of potted plants and the number of drip emitters. A manual or electronically controlled release valve 107 is optionally used to divert part of the water flow from the output of the pump back to the water reservoir or pump intake 123 when the total water flow to the plants is set up to be below a certain threshold. This is be done to ensure that the maximum pressure of the water tubing and the drip emitters is not exceeded under low flow rates since the water pressure at the output of the pump increases with reduction in flow rate. It is also used to ensure that there is a minimum flow that is required for the self-priming of the water pump 106 and to remove air bubbles in the intake path 123. The water pump and the electronic timer 119 could be powered from a transformer-based or a switch mode based DC power supply 117 that converts the home A/C power 115 into DC. An electronic timer 119 turns on the pump and a solenoid valve 113 using either solid-state switches or electromechanical relays 114a and 114b. A rechargeable or non-rechargeable battery backup 122 as shown in FIG. 3 with an electronic switchover within a combined power supply and management unit 117 could be used to power the system during electrical outage of the home A/C power 115. As shown in FIGS. 1 and 3, the system may include a ground fault circuit interrupter (GFCI) protection 116 to shut off the A/C power in case of water spill coming in contact with high voltage terminals. A solenoid valve 113 is used to prevent leakage or siphoning off water from the reservoir to the drip emitters when the pump is turned off.

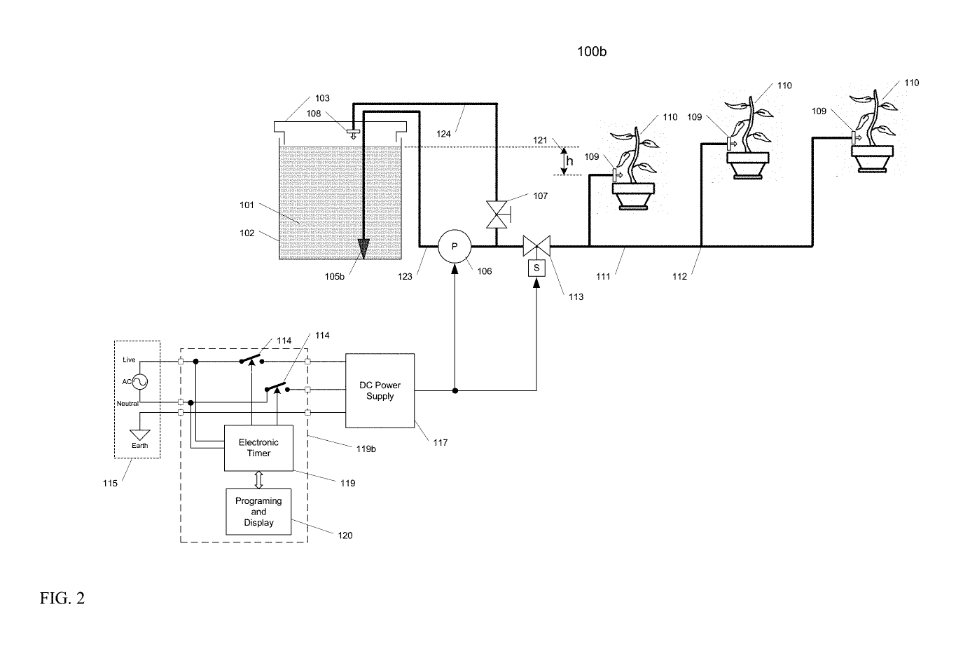

As shown in FIG. 2, an electronic timer 119 with a user interface 120 could be used to switch on the DC power supply 117 periodically. In a typical setup, the electronic timer could be programmed to turn on for 1-3 minutes every day, or every other day. For watering Orchids, it could be programmed to turn once a week.

In one embodiment as shown in FIGS. 1, 2 and 3, the release valve set up comprises a pressure compensated constant flow rate drip emitter 108 e.g. with a rating of 5 GPH, in series with a manually or electronically operated valve 107 that is hereby named a bypass valve. This bypass valve 107 is kept open to enable reflow of water from the pump output back to the water reservoir or pump intake when the total drip rate for the plants is less than a predetermined threshold like 5 GPH in this example. When the total drip rate for the plants is set up to exceed 5 GPH, the bypass valve 107 is kept closed in order to prevent re-flow of water back to the water reservoir or intake. This ensures that the minimum flow rate is at least 5 GPH or a suitable value at the water pump output independent of the total water flow rate to the plants. The mini gear pump 106 is designed such that the output pressure meets the safe operating pressure requirements of the drip emitters 109 and tubing 111 when the total flow rate at the pump output is at a certain value like 5 GPH in this example. As an example, if the operating pressure range of the pressure compensated drip emitters and water tubing is 10-60 psi, then a mini gear pump can be designed to have an output pressure of 45 psi at 5 GPH flowrate. A mini gear pump is preferred over a diaphragm pump as it provides a smooth non-pulsed flow with a fairly constant pressure. A diaphragm pump on the other hand has large pulsed pressure variations and is not conducive for drip emitters for maintaining a constant flow rate, and the pressure may also periodically exceed the rating of the water tubing.

As shown in FIG. 3, the system may include a pressure sensor 121 at the pump output and a closed-loop microcomputer 119c based electronic control system that adjusts the supply voltage or current to the motor of the water pump through solid-state device 121 such that the output pressure is maintained within a required range over a specified range of flowrate. In another embodiment, a microcontroller 119c may be used to sense the output pressure based on which the release valve 107 could be opened should the pressure exceeds a threshold amount. In yet another embodiment, the microcontroller 119c may shut off the water pump 106 should the output steady state pressure be below a certain threshold indicating leakage or breakage in the output tubing 111.

As shown in FIGS. 1, 2 and 3, the system may include an electronically operated valve 113 that could be a solenoid valve, placed in series with the common water tubing 111, in order to prevent leakage or siphoning of water 101 from the reservoir 102 to the drip emitters when the pump 106 is off and if the water 101 level in the reservoir 102 is above that of any of the drip emitters 109 at the plants 110. It prevents leakage or siphoning of water from a higher level to a lower level, when the height “h” 121 in the upward direction from the lowest drip emitter to the reservoir water level as shown in these figures is nonzero. The power supply to this valve 113 is controlled by the same timer that operates the water pump, such that the valve is opened when the pump is operational, and closed otherwise.

In another embodiment, the solenoid valve 113 is place at the input 123 of the water pump 106, for the prevention of siphoning of water when the pump is off.

The system may include buttons, rotary knobs, displays or other human interface devices including trackpad and touch panels 120, for setting the operating parameters and for manually controlling the system when required. The operating parameters can include the number of minutes the pump is activated each time, the number of times per week the pump is activated, or the days of the week the pump is activated, and the starting time. Manual controlling of the system can include manually turning on and off the water pump, and/or testing of other electromechanical components in the system, and for initial priming of the water pump if required. Manual control could include reversing the pump so that water is sucked back from the common tubing and drip emitters in order to flush the system. This can prevents water from dripping onto the floor or carpet from emitters or cut tubing when work is being conducted on the output distribution system for connecting new emitters or new tubing, or when moving the drip emitters or repositioning them.

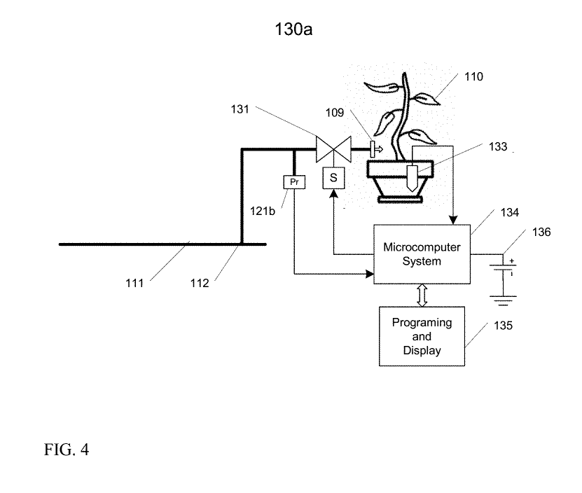

In one embodiment, each potted plant 110 has a drip emitter 109 with a preselected drip rate tailored to the plants watering requirements. In another embodiment 130a, as depicted in FIG. 4, the volumetric flow of water to each plant is additionally locally controlled by a solenoid valve 131 in series with the intake of the pressure compensated drip emitter 109. This allows individually reducing the water flow time to each plant instead of having a fixed flow time that is solely determined by the water pump being on. A local plant soil moisture sensor 133 is used to determine the watering requirements for the plant and the associated control of the solenoid valve 131, by a local microcomputer system 134 with a local battery 136 based power supply. A local water pressure sensor or switch 121b at the solenoid valve's intake is used by the microcomputer system 134 to determine when the water pump is active as indicated by the pressure exceeding a certain threshold value by the pressure sensor. The soil moisture sensor 133 could be a capacitive sensor used for determining the dielectric constant of the soil around it. The dielectric constant of the soil varies with the water content in the soil. Typically the capacitive sensor comprises two isolated metal electrodes in close proximity to each other and encased in FR4 glass-epoxy material that also provides a thin layer of separation between the electrodes and the soil around it. The capacitance between the two electrodes vary with the amount of water in the soil surrounding it. Typically, the two electrodes can be thin copper layers in a printed circuit board. They can be 50 mm long, 5 mm wide with 1 mm gap between them lengthwise. The two electrodes would be covered by 100 um thick FR4 material on the side that is exposed to the soil. The other side would have a much thicker layer of FR4 material for strength and rigidity. Similar electrode structure can be place on the other face of the printed circuit board, for the measurement of capacitance on that side. With such a structure, the capacitance between the electrodes would vary between approximately 5 pF (when in air) and 50 pF (when in water). In the simplest case, the capacitance is measured using digital Input & Output pins of a Microcontroller using well known techniques based on time delay measurement between logic changes between the output pin and the input pin. One of the electrode is connected to electrical ground of the Microcontroller, while the other electrode is connected to the digital input pin. A resistance is connected between the digital output and the digital input pin.

In another embodiment the water tubing 111 of FIG. 4 could be fed from the main water supply pipe in the home through a solenoid valve that is periodically turned on similar to the solenoid valve 113 of FIG. 3. In this case, instead of the water being supplied from a local reservoir, it is supplied from the main water pipe but with a solenoid valve 113 that largely works as a safety device by only periodically allowing water to flow at timed intervals. The local solenoid valve 131 actually controls the watering duration that is less than or equal to the duration that solenoid valve 113 is on.

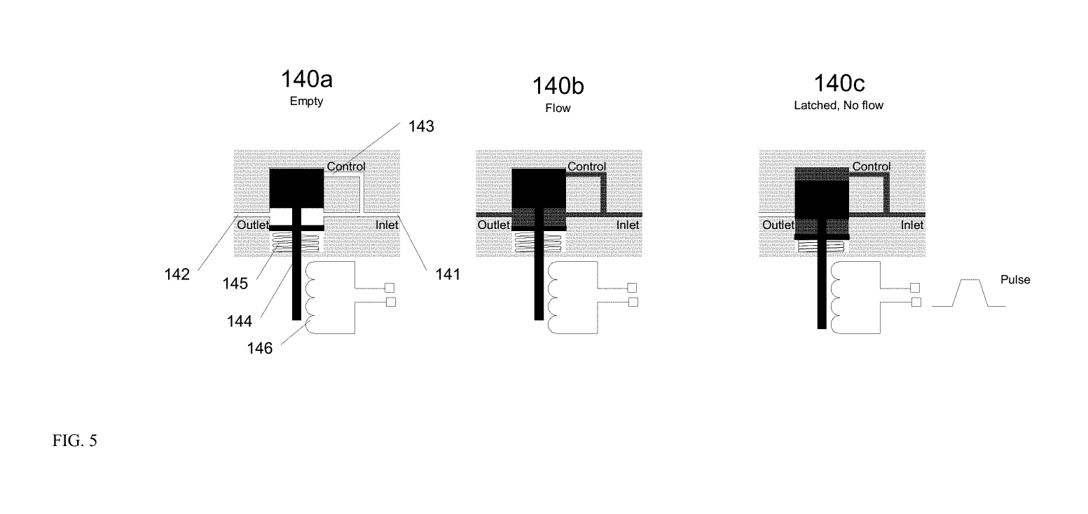

In one embodiment, the local solenoid valve 131 is a latch type that is normally open when electrical power is not applied to the solenoid. Such a latch is depicted as 140a, 140b and 140c in FIG. 5. The valve has external inlet 141 and outlet 142 ports and an internal control port 143 through which water can flow. In a normal state the control port is blocked by the piston 144, and water can flow from the inlet to the outlet, as shown by 140a and 140b. 140a does not have water, and the inlet, outlet and control ports are all empty. 140b shows that the water is flowing from inlet to outlet when no power is applied. To close the valve, only a momentary pulsed electric power supply is required in order to latch the valve to the closed condition as shown by 140c, and this mode of operation is chosen in order to conserve battery drain. When an electrical pulse is applied the piston moves down due to the pulling action of the solenoid on the magnetic material of the piston. The control valve is opened and water pressure further pushes the piston down and holds it in that position even when the electrical power is removed, as depicted in 140c. The valve is designed such that when the input pressure drops below a certain threshold i.e. when the water pump is shut off, the valve is automatically opened by the action of the spring 145 even though no electrical power is applied or removed, as shown in 140a.

Alternatively, the solenoid valve 131 could be latched-on and latched-off type using pulsed electric power under the control of the local microcomputer interfacing through solid-state switches or electromechanical relay switches. Such a valve could use permanent magnets to hold the piston in a latch on position and latched off position. Electrical pulses are applied to 2 different solenoids, one to latch on and the other to latch off, each pulling the magnetic material 144 in opposite directions when acticated.

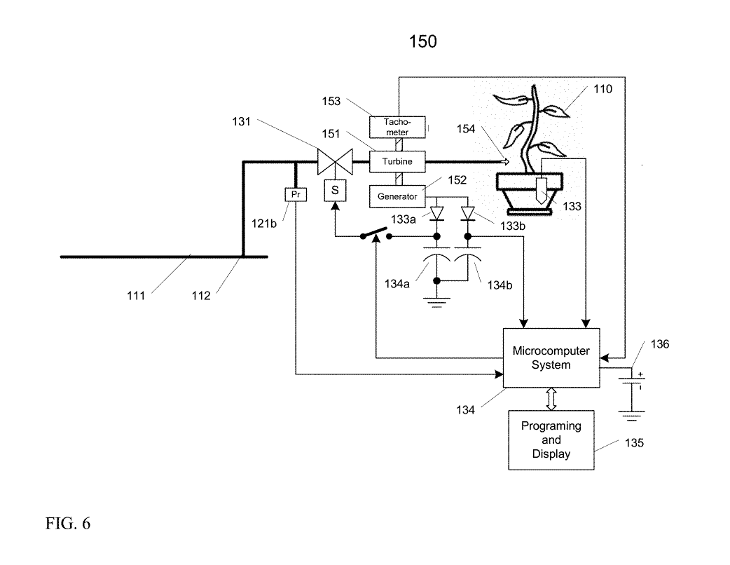

In one embodiment, as shown in FIG. 6, a local miniature water turbine 151 at each plant 110 is used to generate electricity for its local watering control and monitoring system. The principle is similar to that of a hydroelectric power station, but at a miniature scale. The turbine 151 rotates a generator 152 that charges super capacitors 134a/b through diodes 133a/b. The generated electricity is used to charge capacitors that are used to power the local microcomputer 134 and soil moisture sensing system 133, and the pulsed solenoid valve 131. In this case the pressure compensated drip emitters are not used for the local watering control. The total water flow through the water turbine 151 is measured using a flow sensor or tachometer 153 that could be part of the water turbine for counting the total number of revolutions of the turbine. When a predetermined amount of water has flowed through the turbine 151, the latched solenoid valve 131 placed at the input of the turbine, is used to shut off the water flow. When the water pressure drops after the water pump has been shut off, the solenoid valve can be re-opened either by the microcomputer 134 or by the self-acting valve 131 itself. A pressure switch or a pressure sensor 121b at the input of the solenoid valve can be used by the microcomputer 134 to determine the water pressure. As depicted in FIG. 6, a backup battery 136 could be used for powering a real-time clock within the microcomputer system. It could also power the microcomputer system itself. A human interface 135 is used for displaying and programming the local watering and monitoring system.

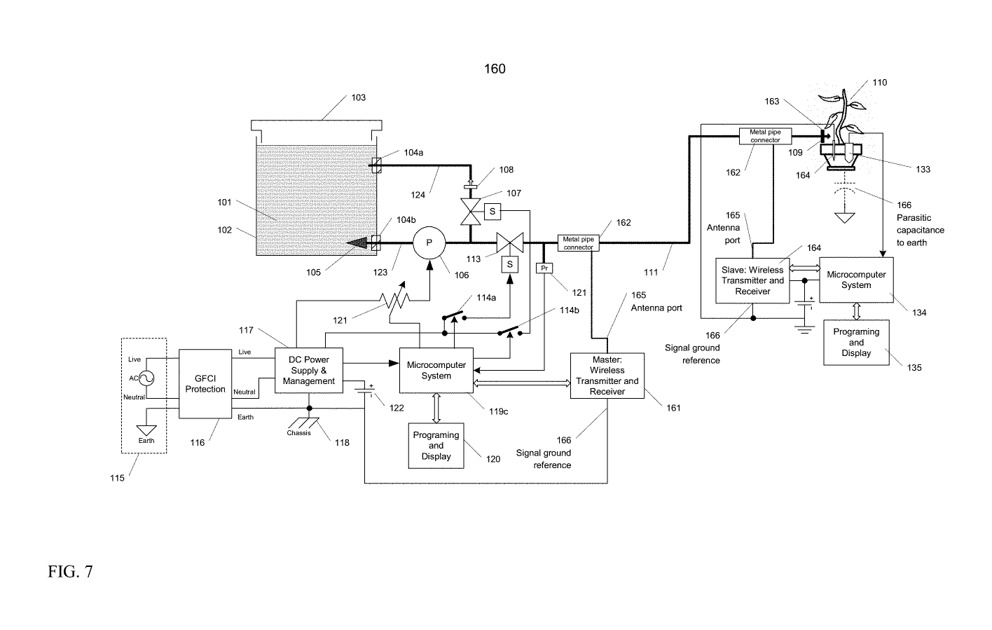

In one embodiment, as shown in FIG. 7, the water in the common tubing 111 that feeds water to each plant, is used as a conductive electrical communication physical channel over which electronic transceivers 164 that are placed at each plant (Slave) can communicate with a master controller or network hub (Master) comprising of microcomputer 119c and Wireless Transmitter/Receiver (Transceiver) 161 with antenna port 165 that is attached anywhere to the water tubing or preferably at the water pump where AC electric power is available. The electronic transceivers 164 are used for reporting soil moisture contents and soil temperatures at one or more measuring spots in the soil. It can also report local conditions like temperature, humidity and light intensity. It can also receive commands to actuate the solenoid valve 131 to water the local plant. The electronic transceivers 164 and the Wireless Transmitter/Receiver (Transceiver) 161 can be either wireless or wired or both. In one embodiment, the water in the water tubing 111 can act as the wired or wireless communication medium. The water tubing 111 can be made of nonconductive plastic material. In one embodiment the water in the common tubing is used for conducting electrical energy for the wireless communication among the transceivers 164 and 161, much like a wired connection with a distributed series resistance, and a distributed shunt capacitance to ground. In this case the wavelength of the subcarrier that is used for the wireless communication is greater or comparable to the length of the water tubing. In another embodiment the water in the common tubing is used for radiating electrical energy for the wireless communication among the transceivers, like an antenna. In this case the wavelength of the subcarrier that is used for wireless communication can be smaller than the length of the water tubing. In the case where conductive electrical energy is used for the wireless communication through the water tubing, the return path comprises of the parasitic capacitance 166 of individual plant pots with respect to the earth ground. The transceiver at the network hub could have a ground connection directly with the earth ground of the home wiring 115. Alternatively, the water 101 in the reservoir 102 along with its parasitic capacitance to earth's ground, could be used as a reference ground. In this case the significant electrical resistance that is present in the water section between the reservoir and the common tubing at the network hub transmit/receive port would prevent short-circuiting of the electrical communication energy for the network hub. At the potted plants a diffuser is optionally used at the drip emitter (shown combined with drip emitter as 163) to ensure that the water does not form a continuous electrically conducting column that could significantly short the electrical energy in the water tubing to the plant soil that is used as a reference ground by the local wireless transceiver using a stake 167. The electrical connection of the transceiver's transmit and receive ports with the water in the common tubing can be implemented using a conductive probe piercing through the nonconductive tubing, or by inserting a short piece of conductive tubing 162 in the path of the water flow. In one embodiment the tubing itself could be made of conductive material or have a conductive coating either on the inside or outside or both. The conductive part of the tubing could be used for conducting or radiating electrical communication energy, and for making electrical contacts with the transmit/receive port 165 of the wireless transceivers 164/161. In another embodiment, a conductive wire or cable could be used in place of the conductive tubing or the water in the tubing, for electrical communication.

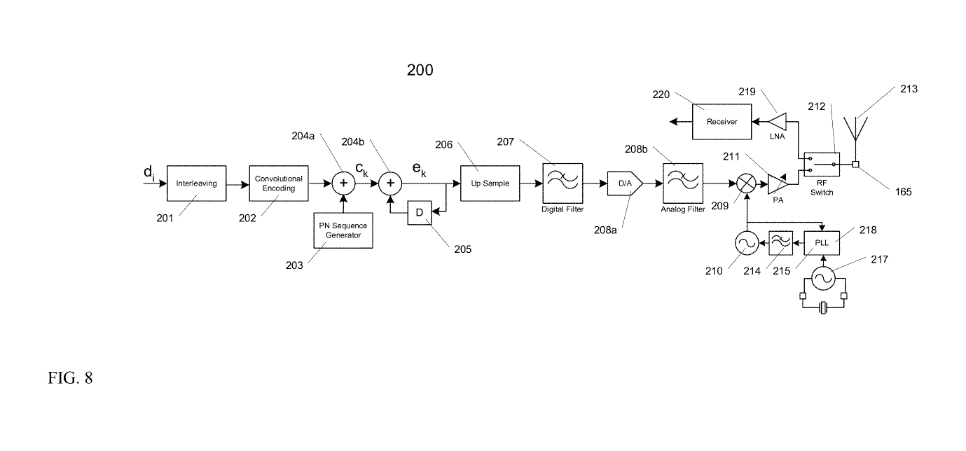

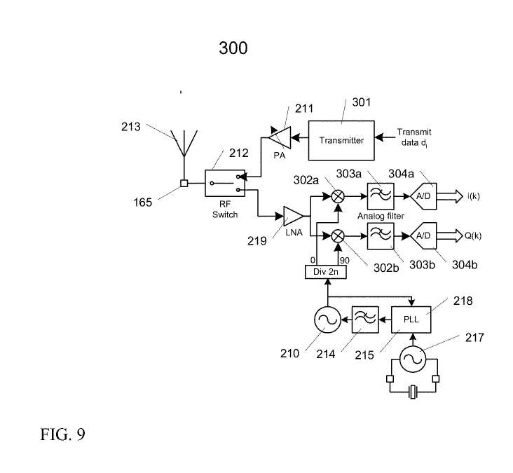

In one embodiment, a dedicated electrical radiating and receiving antenna ie. a wireless antenna 213 at each transceiver 200 is used for the wireless communication, as depicted in FIGS. 8 and 9. The trasnceivers 161 and 164 of FIG. 7 are depicted each by a transceiver 200. Transceiver 200 uses a radiating and receiving antenna 213, and would not need a stake 167 as grounding, and would not need water tubing 111 for the communication medium. In another embodiment, the wireless transceivers 200 could communicate directly with a home/office wireless access point that could include Wi-Fi or other public standards or proprietary standards based system.

In one embodiment, as shown in FIGS. 8, 9, 10 and 11, a wireless communication system for sensing, monitoring and control using either a dedicated antenna 213 or the water tubing 111 as either an antenna or as a conductive electrical communication medium, comprises of a digital spread Spectrum system wherein data d₁ to be transmitted is first interleaved by 201 followed by convolutional encoding by 202, followed by spreading using a modulo-2 adder 204a and a pseudorandom code based chip generator 203. The resulting spread signal cₖ is further differentially encoded for implementing chip level differential binary phase shift keying encoding using 204b modulo-2 adder and a chip-delay 205. The differential binary phase shift keying encoding is incorporated at the chip level after the spreading. Additionally, forward error correction is incorporated for the source data before spreading, using interleaving 201 and convolutional encoding 202. As shown in FIG. 8, the differentially binary phase shift encoded spread the data is up sampled by 206, digitally filtered by 207 for spectral shaping, and then converted to an analog signal by digital to analog converter 208a. An anti-aliasing analog filter 208b provides further spectral shaping to the modulated signal after which it is a up converted by a mixer 209, and amplified by a RF power amplifier 211 and sent to an antenna 213 through an RF switch 212. The modulated carrier frequency can be chosen to be anywhere from 100 kHz to 6 GHz. The carrier center-frequency is generated by a frequency synthesiser comprising of a voltage controlled oscillator 210 controlled by a phase locked loop 218, a loop filter 214, and a reference phase detector frequency using a crystal oscillator 217 and a crystal. Differential phase shift keying is performed at the chip level in order to relax the allowed relative frequency error limit between a transmit device and a receive device. Additionally, carrier recovery and coherent demodulation are not required with the differential encoding at the chip level. The wireless communication system comprises a star network in which communication occurs between the central hub called the Master, and the sensor and/or control units called the slaves. The hub could be based on a microcomputer and transceiver located at the water pump where AC or large battery power is available, or it could be located elsewhere. The hub works as a gateway for the sensors and controllers, and can be connected to the home networking through ethernet, Bluetooth, Zigbee, IEEE802.15.4g, Wi-Fi or other suitable means. The monitoring and control aspects of the plant watering can be done over the Internet Cloud through a web server.

In one embodiment. most of the slaves are battery powered and can transmit randomly in an uncoordinated manner. In order to save battery power the uncoordinated slaves only turn on their receiver after one or more predetermined delays after the end of their last transmission. Their receiver is used for receiving data and acknowledgements from the Master. This predetermined delays are optionally conveyed as part of the transmit data from the slave to the master. The master only transmits to any slave precisely after this predetermined delay from the end of transmission by that particular slave. By adopting this method, the slaves do not need to wake up periodically for synchronisation with the master or with other slaves, thereby significantly reducing battery drain. In case of a lost packet e.g. due to interference or fading, a slave would not receive a valid (error free) signal from the master after this predetermined duration, or would receive a valid negative acknowledgement signal from the master indicating corruption of the received signal at the master. In either case the slave would retransmit again after a random duration. By randomising the start of the transmit time, the slaves minimise collisions among themselves. A collision between the slaves would only occur if the start time offset between any two slaves is on the order of 0-2 chip duration since any duration larger than this would result in close to 0 cross correlation of their chip sequences. Some of the slaves could be transmit only devices e.g. those used simply for monitoring soil moisture content, or for monitoring opening and closing of doors and windows in other monitoring systems. For the uplink i.e. transmission from slaves to master, all slaves would use an identical PN spreading code sequence. The transmit frequency would preferably be in an unlicensed band like 900 MHz, 2.4 GHz or 5 GHz. For the downlink i.e. transmission from master to slaves, preferably a different and non-overlapping frequency band would be used, and also preferably in an unlicensed band. By using different frequencies for the uplink and downlink, collisions are avoided between master and slaves. However, in a lightly loaded network the uplink and downlink frequencies could be the same as it would only have a small impact on the battery drain of the slave units due to occasional collisions between master and slaves. In this case the PN code for the downlink is preferably different from that of the uplink with close to zero cross-correlation between them. Gold codes or Complimentary code sequences could be selected for these PN code sequences.

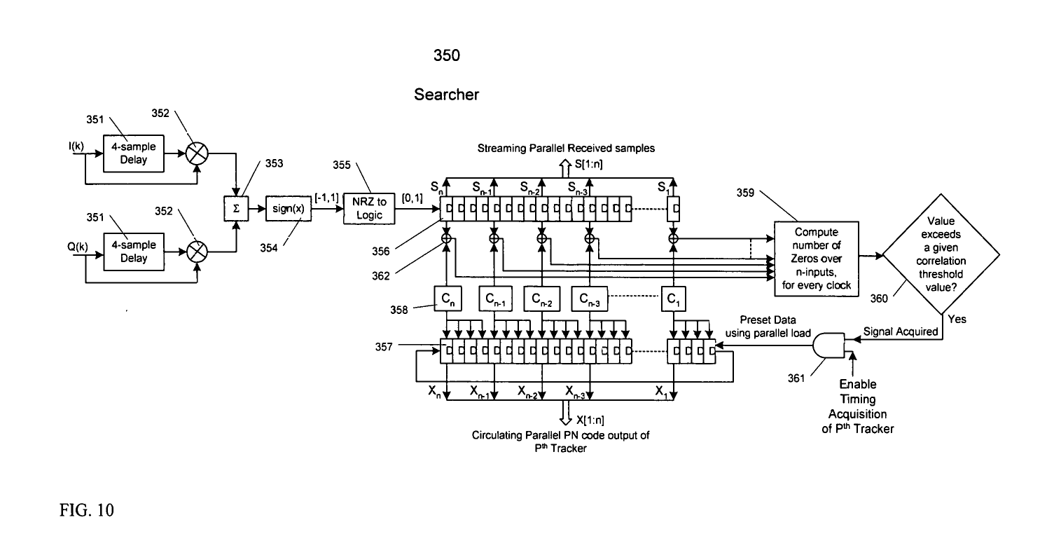

In one embodiment, the slaves could either successively or simultaneously transmit the same data over different frequency bands, and with optional random time offsets between each successive transmission in order to overcome any deliberate jamming attempts by intruders. The master would simultaneously listen to each of these frequency bands. The received modulated signal in each frequency band could be down converted by the master to complex signal comprising of in-phase and quadrature-phase zero IF baseband signals as depicted in FIG. 9. An antenna 213 couples receive signal through an RF switch 212 to a low noise amplifier 219, after which it is down converted to in-phase and quadrature phase zero-IF signals using mixers 302a/302b. Channel filtering is provided by analog filters 303a/b, after which the signals are digitised by analog to digital converters 304a/b. Though not shown, DC offset cancellation is incorporated in the received signal path. If the spreading pseudorandom code is DC balanced, then an AC coupling could be used for the in phase and quadrature phase signal paths. The local oscillator for the down conversion is based on a voltage controlled oscillator 210 driven by a phase locked loop 218 and loop filter 214 that is common to the transmitter. The local oscillator has an in-phase and quadrature phase component that can be generated using a frequency divider. The VCO itself in this case would be operating at a higher frequency compared to the carrier frequency of the signal. When multiple receivers are used simultaneously at the hub at different frequency bands, it would be expensive to have individual baseband modem for each receiver. A low-cost workaround is to sum the complex analog signal from each receive path before digitizing them using analog to digital converters, and then feeding to a common complex differential binary phase shift keying decoder followed by a spread spectrum decoder. A complex binary phase shift keying decoder is shown in FIG. 10, comprising of the blocks 351 for a single-chip delay, 352 for multiplication and 353 for summation. The polarity of the signal at the summation output is determined by the block 354 as +1 or −1, after which the signal is converted to logic zero and one. This method of differential binary phase shift keying decoding is insensitive to small changes in carrier phase over chip interval and therefore allows usage of low-cost crystals with large frequency tolerance. Since each frequency band could have a different propagation delay, a raked receiver can be used to combine the despread energy from all the paths. Here each rake receiver would have its own tracking and despreading. The rakes can also be used to track different multipaths within each frequency band.

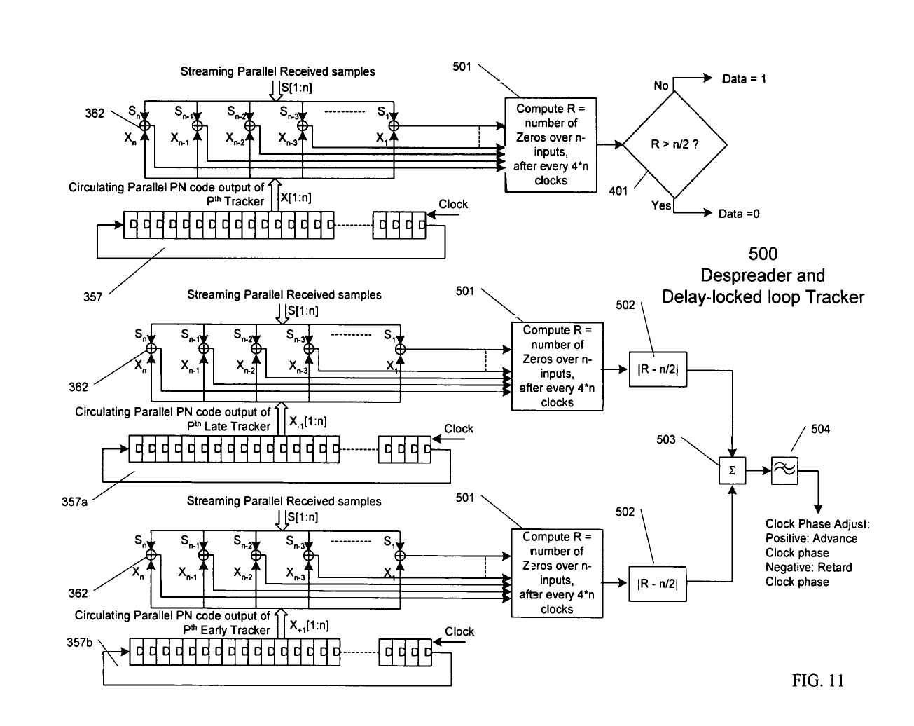

In one embodiment, as shown in FIG. 10, a spread spectrum Searcher 350 is capable of performing a full-length PN code sequence correlation with the incoming signal for every sample of the signal. It is used for continuously searching for relevant spread spectrum signals with a matching PN code, and their detection. When a strong correlation is detected at a particular sample of the input signal stream, the corresponding timing offset information (relative to a notional reference time) is handed over to a tracking and despreading system of FIG. 11 that uses a delay locked loop for maintaining code synchronisation for the de-spreading of that particular signal with that particular timing offset. Multiple tracking systems can be used in the master for simultaneously receiving overlapped signals from different slaves in order to reduce their battery drain from retransmissions due to failed acknowledgements or negative acknowledgements from the master. As noted before, in order to avoid collision the overlapping signals from different slaves must have a time offset off two or more chips between them. The time offset is computed using modulo arithmetic with the PN code sequence duration as a repetition interval. The full-length PN code sequence correlator in FIG. 10 comprises shift register 356 that shifts the input samples. Every 4^{th} parallel output of the shift register is compared to a code sequence Cn 358 using modulo-2 adder (EXOR) 362. Every 4^{th} output is taken because there are 4 samples pere chip due to oversampling at the receiver. The number of matches in the comparison is determined by 359 that provides the correlation output. When the correlation output of 359 exceeds a threshold value as determined by 360, a valid signal acquisition is detected and the relative timing information is taken using the parallel output of shift register 357 that actually keeps circulating the oversampled correlation code sequence Cn. The AND gate 361 is used to sample the phase of the correlation code sequence at the instance of signal acquisition. The despreader in FIG. 11 as shown in the upper section of the figure, comprises modulo-2 adders 362, circular shift register 357, correlation estimator 501, and data decoder 401. While despreaders are usually done serially once signal has been acquired, it can also be done in a parallel way as in FIG. 11. Here, n samples of output of 355 (NRZ to Logic converter of FIG. 10) are correlated with n chips of the code sequence. There are n chips per symbol or coded data bit. If the correlation exceeds n/2 in block 501, a data ‘1’ is decoded by 401, else a data ‘0’ is decoded. Due to timing drifts arising from crystal clock reference frerquency errors, and due to changes in multipath propagation delays of the received signal, the sample point in a chip interval needs to be adjusted. It is done by a tracker as shown in FIG. 11 lower section. It comprises of two banks of correlators, one with an early clock phase and one with a late clock phase. The difference in their correlation output is provided by 303 that is low pass filtered by 504. If output of 504 is positive, the correlator clock phase is advanced, otherwise it is retarded.

In one embodiment, the wireless communication system uses encryption technology that is based on transferring a secret key from the master to a new slave that needs to be introduced into the network. The key transfer could be done using a hardwired USB connection or by manually entering a code, for transmit only slaves, or using two-way communication for Transmit/Receive capable slaves. In order to prevent impersonation, a rolling code or message count can be used as part of the message for transmit only slaves, wherein every transmit packet has a new code or message count when compared to a large number of consecutive previous course or future codes.

In another embodiment, instead of using just differential encoding at the chip level, M-ary modulation is first used. For example with M=16, four encoded data bits dᵢ represent a symbol, out of 16 unique symbols. Each symbol is assigned a unique Walsh-Hadamard code for a 1^{st} level of spreading. In another embodiment using bipolar M-ary modulation, only half the symbols are used for selecting a unique Walsh-Hadamard code for a 1^{st} level of spreading. The remaining second half of the symbols that are the 1's complement of the first half, use the inverted Walsh-Hadamard code sequence of the first half. In another embodiment, a Pilot signal is added to the data signal. The Pilot uses its own unique Walsh-Hadamard code for spreading. After the 1^{st} level of spreading using Walsh-Hadamard code that are symbol dependent, a second level of spreading is done using a much longer Gold code sequence. After this, differential encoding can be optionally done at the chip level. In one embodiment, a preamble is used at the start of the transmit packet for providing signal acquisition and carrier recovery time at the receiver. In one embodiment, the Preamble is the Pilot itself but optionally at a larger signal level. In another ambodiment, the Preamble uses a unique Walsh-Hadamard code for the 1^{st} level spreading.

What is claimed is:

1. A method of watering plants, the method comprising:
providing a water reservoir that is exposed to atmospheric pressure;
providing a mini gear pump that pumps water from said reservoir to said plants;
providing one or more pressure compensated drip emitters that provide a constant flow rate of water to individual plants over a wide range of water pressure;
providing a common high pressure water tubing that transports water from said pump to said drip emitters;
providing programmable electronic timer that can turn on said water pump for a user programmable time duration at a user programmable repetition interval;
providing electrical power supply to power said water pump and said electronic timer.

2. The method of claim 1 further comprising of providing a water reflow path from output of said pump back to said reservoir whereby self-priming of said pump and removal of air in intake path of said pump are accomplished by maintaining a minimum needed water reflow rate.

3. The method of claim 2 further comprising of providing a pressure compensated drip emitter in said path of water reflow wherein a constant water flow rate is maintained in said reflow path.

4. The method of claim 1 further comprising of providing a solenoid valve in series with said water tubing wherein said solenoid valve is normally closed to prevent water flowing from said reservoir to said plants when said pump is switched off, and wherein said solenoid valve is opened by said electronic timer when said pump is switched on in order to enable water to flow to said plants.

5. The method of claim 1 further comprising of providing a local solenoid valve placed in series with intake of said pressure compensated drip emitter at said individual plants, allowing individual reduction of water flow time to each plant instead of having a fixed maximum flow time that is determined by the duration of said water pump being switched on, wherein said local solenoid valve is locally controlled.

6. The method of claim 5 further comprising:
providing a local plant soil moisture sensor at each individual plant;
providing a local water pressure sensor at said local solenoid valve's intake for determining when said water pump is active as indicated by a pressure exceeding a certain threshold value;
providing a local microcomputer with a local battery based power supply at said individual plant for a) controlling said solenoid valve for watering of said plant, b) sensing soil moisture using said soil moisture sensor for determining watering requirements, c) sensing water pressure using said pressure sensor or switch for turning on and off of said local solenoid valve.

7. The method of claim 5 wherein said local solenoid valve is of a latched type requiring only an electrical pulse for activation and optionally deactivation, and not requiring continuous electrical power for activation or deactivation, in order to significantly save local electrical power consumption.

8. The method of claim 5 further comprising of providing a water driven turbine at said local plant for generating electricity for watering control purpose, or for measuring water flow for measuring water dosage using a coupled tachometer.

9. A method of watering plants, the method comprising:
providing one or more pressure compensated drip emitters that provide a constant flow rate of water to individual plants over a wide range of water pressure;
providing a common high pressure water tubing that transports water to said drip emitters from a water source;
providing locally controlled solenoid valve in series with intake of said pressure compensated drip emitter, for controlling water flow to said plant;
providing a local plant soil moisture sensor;
providing a local microcomputer with a local battery based power supply for a) controlling said solenoid valve for watering of said plant, b) sensing soil moisture using said soil moisture sensor for determining watering requirements for said plant

10. The method of claim 9 wherein said local solenoid valve is of a latched type requiring only an electrical pulse for activation or deactivation, and not requiring continuous electrical power for activation or deactivation, in order to significantly save local electrical power consumption.

11. The method of claim 9 further comprising of providing a local water pressure sensor at said local solenoid valve's intake for determining when said high pressure water tubing has water available as indicated by said pressure sensor output exceeding a certain threshold value wherein said microcomputer uses said pressure information for controlling watering to said plant;

12. The method of claim 11 further comprising of providing a common solenoid valve for connecting said high pressure water tubing to a common water supply for all said local plants, wherein said common solenoid valve is activated periodically to mitigate the risk of heavy flooding due to any broken water connection.

13. The method of claim 9 further comprising of providing a water driven turbine at said local plant for generating electricity for watering control, or for measuring water flow for measuring water dosage using a coupled tachometer.

14. The method of claim 9 further comprising of providing a wireless networking system with a communication physical channel that is comprised of the water in said water tubing wherein said wireless networking system facilitates plant watering monitoring, control and programming, for said plants.

15. The method of claim 9 further comprising of providing a wireless networking system with a communication physical channel that is selected from the group comprising of a) a common wire connecting all terminals of said network, b) a wireless antenna, c) water in said water tubing, wherein said wireless networking system facilitates plant watering monitoring, control and programming, for said plants.

16. The method of claim 15 further comprising of providing wireless network terminals in said wireless network using direct sequence spread spectrum with optional chip-level differential encoding for the transmission of information by said terminals;

17. A method of wireless networking for plant watering and general sensing and control, the method comprising:
providing a master and one or more slave wireless network terminals in said wireless network using direct sequence spread spectrum with optional chip-level differential encoding for the transmission of information by said terminals;
transmitting packets by some of said slave terminals in an uncoordinated manner;
receiving of signal or packet by said uncoordinated slave network terminals after one or more predetermined delays that are measured from the end of transmission by said uncoordinated slave terminals;

18. The method of claim 17 further comprising of providing said master terminal comprising:
providing a water reservoir that is exposed to atmospheric pressure;
providing a mini gear pump that pumps water from said reservoir to said plants;
providing one or more pressure compensated drip emitters that provide a constant flow rate of water to individual plants over a wide range of water pressure;
providing a high pressure water tubing that transports water from said pump to said drip emitters;
providing programmable electronic timer that can turn on said water pump for a user programmable time duration at a user programmable repetition interval;
providing electrical power supply to power said water pump and said electronic timer;
providing a wireless networking communication physical channel that is chosen from a group that is comprised of a) the water in said water tubing, b) a conductive coating in said tubing, c) a conducting wire or cable, d) a wireless antenna;

19. The method of claim 17 further comprising of providing said slave terminals comprising:
providing one or more pressure compensated drip emitters that provide a constant flow rate of water to individual plants over a wide range of water pressure;
providing a common high pressure water tubing that transports water to said drip emitters from a water source;
providing locally controlled solenoid valve in series with intake of said pressure compensated drip emitter, for controlling water flow to said plant;
providing a local plant soil moisture sensor;
providing a local microcomputer with a local battery based power supply for a) controlling said solenoid valve for watering of said plant, b) sensing soil moisture using said soil moisture sensor for determining watering requirements for said plant

20. The method of claim 17 further comprising:
transmitting by slave terminals in one or more frequency bands either simultaneously or sequentially;
providing M-ary modulation for transmitter symbols comprising of coded and interleaved data;
providing direct sequence spreading of said M-ary modulated symbols, before said optional chip-level differential encoding;
receiving multiple frequency bands simultaneously by said master with separate receiver for each band wherein down converted and filtered analog signals from all receivers are combined into a common analog signal and then despread along with optional chip level differential decoding;
providing raked receivers at master to track different multipaths at each frequency band;
providing raked receivers at slaves to track different multipaths of received signal.
